(19) United States
(12) Patent Application Publication
(10) Pub. No.: US 2025/0232433 A1
(43) Pub. Date: Jul. 17, 2025

(54) IMAGE CLASSIFICATION AND COMPARISON FOR ASSET INSPECTION SYSTEMS AND METHODS

(71) Applicant: FLIR Systems AB, Täby (SE)

(72) Inventors: Stefan Bergström, Täby (SE); Torsten Sandbäck, Stockholm (SE); Lukas Segelmark, Solna (SE)

(21) Appl. No.: 19/097,693

(22) Filed: Apr. 1, 2025

Related U.S. Application Data
(63) Continuation of application No. PCT/US2023/075993, filed on Oct. 4, 2023.
(60) Provisional application No. 63/413,368, filed on Oct. 5, 2022.

(51) Int. Cl. G06T 7/00; G06T 7/50; G06V 10/764; H04N 23/60

(52) U.S. Cl. CPC G06T 7/001; G06T 7/50; G06V 10/764; H04N 23/64; G06T 2207/20092

(57) ABSTRACT

Systems and methods directed to image classification using image comparison are provided. In one example, a method includes capturing, by a camera, a current image of an asset under inspection, wherein the current image includes at least one inspection point of the asset. The method further includes presenting the current image relative to a previous image of the asset for comparison, wherein the previous image includes the at least one inspection point of the asset. The method further includes receiving a classification of the current image based on a comparison between the current image and the previous image. Additional methods and systems are also provided.

### CROSS REFERENCE TO RELATED APPLICATIONS

This application is a continuation of International Patent Application No. PCT/US2023/075993 filed Oct. 4, 2023 and entitled “IMAGE CLASSIFICATION AND COMPARISON FOR ASSET INSPECTION SYSTEMS AND METHODS,” which claims priority to and the benefit of U.S. Provisional Patent Application No. 63/413,368 filed Oct. 5, 2022 and entitled “IMAGE CLASSIFICATION AND COMPARISON FOR ASSET INSPECTION SYSTEMS AND METHODS,” all of which are incorporated herein by reference in their entirety.

### TECHNICAL FIELD

The present invention relates generally to asset inspection and, more particularly, to image-based classification of assets to facilitate inspection.

### BACKGROUND

In industrial environments such as manufacturing facilities or other locations, there is often a need to inspect various assets such as machines, electronics, or other devices. In many cases, the assets may be temperature-sensitive and therefore required to operate at temperatures within expected tolerances to facilitate ongoing reliable functionality. For example, if an asset exhibits a temperature that is too high or too low, this may indicate a fault in need of repair.

Various conventional techniques exist for monitoring assets. In some cases, a user may be required to manually inspect the assets. However, this approach can be subject to human error as it puts the responsibility on the user to properly monitor the condition of the asset repeatedly. Accordingly, there is a need for an improved approach to asset monitoring.

### SUMMARY

According to various embodiments of the present disclosure, a method includes capturing, by a camera, a current image of an asset under inspection, wherein the current image includes at least one inspection point of the asset. The method further includes presenting the current image relative to a previous image of the asset for comparison, wherein the previous image includes the at least one inspection point of the asset. The method further includes receiving a classification of the current image based on a comparison between the current image and the previous image.

According to various embodiments of the present disclosure, a method includes receiving, by a server from a camera, a current image of an asset under inspection, wherein the current image includes at least one inspection point of the asset. The method further includes providing, by the server, a previous image of the asset for comparison against the current image, wherein the previous image includes the at least one inspection point of the asset. The method further includes receiving, by the server, a classification of the current image based on a comparison between the current image and the previous image.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an inspection system and a remote system, in accordance with an embodiment of the disclosure.

FIG. 2 illustrates a diagram of an operations system, in accordance with an embodiment of the disclosure.

FIG. 3 illustrates a three-dimensional scan of an asset under inspection, in accordance with an embodiment of the disclosure.

FIG. 4 illustrates a thermal image of an inspection point, in accordance with an embodiment of the disclosure.

FIG. 5 illustrates identification of an inspection point, in accordance with an embodiment of the disclosure.

FIG. 6 illustrates a guided image capture of an asset under inspection, in accordance with an embodiment of the disclosure.

FIG. 7 illustrates an annotation of a current image of an asset under inspection, in accordance with an embodiment of the disclosure.

FIG. 8 illustrates a diagram of displaying multiple images of an asset under inspection, in accordance with an embodiment of the disclosure.

FIG. 9 illustrates a comparison between current and previous images of an asset under inspection, in accordance with an embodiment of the disclosure.

FIG. 10 illustrates a classification of a current image of an asset under inspection, in accordance with an embodiment of the disclosure.

FIG. 11 illustrates a classification selection of a current image of an asset under inspection, in accordance with an embodiment of the disclosure.

FIG. 12 illustrates a diagram of an inspection board, in accordance with an embodiment of the disclosure.

FIG. 13 illustrates a flow diagram of a process of classifying a current image of an asset under inspection, in accordance with an embodiment of the disclosure.

FIG. 14 illustrates a flow diagram of another process of classifying a current image of an asset under inspection, in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

Embodiments of the present disclosure provide systems and methods for image classification and comparison for asset inspection. A user may utilize historical asset data (e.g., previous images) and contextual information (e.g., annotations, notes, etc.) to determine a current state of an asset under inspection. For example, a current image of an asset may be compared against one or more previous images of the asset to understand the asset's current state (e.g., thermal state, operational state, etc.).

A health status may be determined per image of the asset under inspection. For instance, a user or system may set a health status on the current image based on a comparison with one or more previous images. The health status may be assigned or set through annotation of the current image and/or selection of one of multiple preset levels (e.g., OK, Minor, Major, Critical, etc.). Additional annotation of the current image may be captured, such as notes or information regarding image capture, environmental conditions, the user's understanding of asset operation, etc.

The health status may be presented for quick and clear understanding, such as in an inspection board for multiple assets. The inspection board may provide an overview of all assets under inspection. The inspection board may allow quick access to, and presentation of, inspection data for each asset, which may facilitate the identification of critical issues and trending.

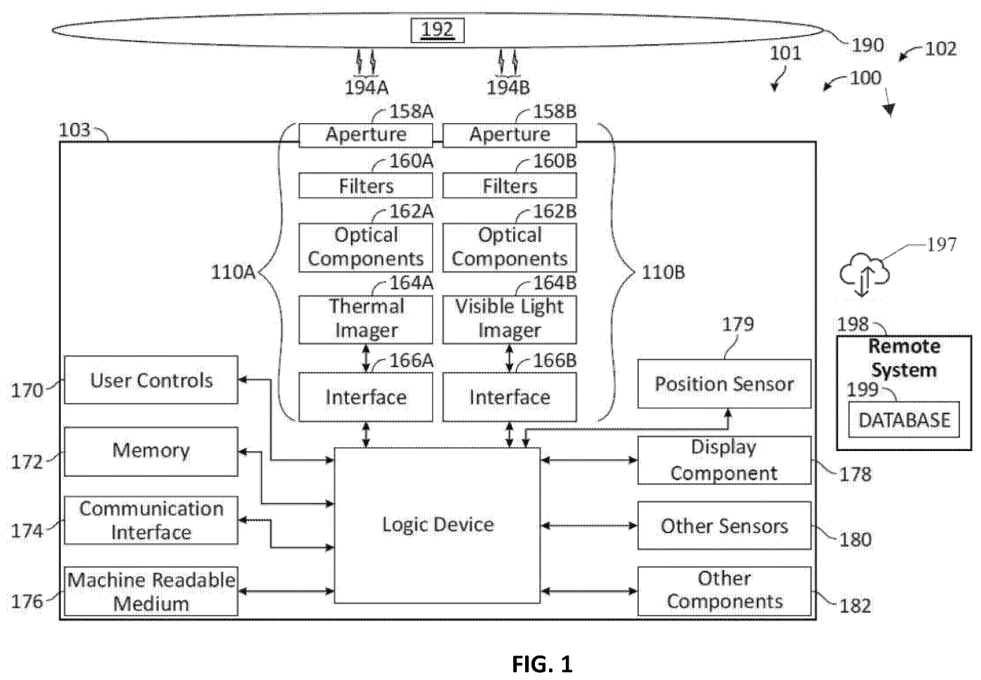

FIG. 1 illustrates a block diagram of an inspection system 100 comprising a portable device 101 and a remote system 198 in accordance with an embodiment of the disclosure. In some embodiments, portable device 101, which may be referred to as an imaging system or simply a camera, may be implemented, for example, as a handheld camera system, a small form factor camera system provided as part of part of and/or an attachment to a personal electronic device such as a smartphone, or as another device.

Portable device 101 may be positioned to receive infrared radiation 194A and/or visible light radiation 194B from a scene 190 (e.g., corresponding to a field of view of portable device 101) in an environment 102 (e.g., a workplace, warehouse, industrial site, manufacturing facility, or other environment). In various embodiments, scene 190 may include one or more physical assets 192 (e.g., temperature-sensitive machines, equipment, electronics, or other devices) of interest which may be captured in thermal images and/or visible light images by portable device 101. Although a single example asset 192 is illustrated in FIG. 1, any desired number of assets may be inspected in accordance with the techniques of the present disclosure.

As shown, portable device 101 includes a housing 103 (e.g., a camera body graspable by a user), a thermal imaging subsystem 110A, a visible light imaging subsystem 110B, a logic device 168, user controls 170, a memory 172, a communication interface 174, a machine readable medium 176, a display component 178, a position sensor 179, other sensors 180, and other components 182, or any combination thereof. Such embodiments are illustrative only, and portable device 101 may include other components facilitating the operations described herein.

Thermal imaging subsystem 110A and visible light imaging subsystem 110B may be used to capture thermal images and visible light images in response to infrared radiation 194A and visible light radiation 194B, respectively, received from scene 190.

Thermal imaging subsystem 110A may include an aperture 158A, filters 160A, optical components 162A, a thermal imager 164A, and a thermal imager interface 166A. In this regard, infrared radiation 194A passing through aperture 158A may be received by filters 160A that selectively pass particular thermal wavelength ranges (e.g., wavebands) of infrared radiation 194A. Optical components 162A (e.g., an optical assembly including one or more lenses, additional filters, transmissive windows, and/or other optical components) pass the filtered infrared radiation 194A for capture by thermal imager 164A.

Thermal imager 164A may capture thermal images of scene 190 in response to the filtered infrared radiation 194A. Thermal imager 164A may include an array of sensors (e.g., microbolometers) for capturing thermal images (e.g., thermal image frames) of scene 190. In some embodiments, thermal imager 164A may also include one or more analog-to-digital converters for converting analog signals captured by the sensors into digital data (e.g., pixel values) to provide the captured images. Thermal imager interface 166A provides the captured images to logic device 168 which may be used to process the images, store the original and/or processed images in memory 172, and/or retrieve stored images from memory 172.

Visible light imaging subsystem 110B may include an aperture 158B, filters 160B, optical components 162B, a visible light imager 164B, and a visible light imager interface 166B. It will be appreciated that the various components of visible light imaging subsystem 110B may operate in an analogous manner as corresponding components of thermal imaging subsystem 110A with appropriate technology for capturing visible light images.

Moreover, although particular components are illustrated for each of thermal imaging subsystem 110A and visible light imaging subsystem 110B, it will be understood that the illustrated components are provided for purposes of example. As such, greater or fewer numbers of components may be used in each subsystem as appropriate for particular implementations.

Logic device 168 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 168 is configured to interface and communicate with the various components of portable device 101 to perform various method and processing steps described herein. In various embodiments, processing instructions may be integrated in software and/or hardware as part of logic device 168, or code (e.g., software and/or configuration data) which may be stored in memory 172 and/or a machine readable medium 176. In various embodiments, the instructions stored in memory 172 and/or machine readable medium 176 permit logic device 168 to perform the various operations discussed herein and/or control various components of portable device 101 for such operations.

Memory 172 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory.

Machine readable medium 176 (e.g., a memory, a hard drive, a compact disk, a digital video disk, or a flash memory) may be a non-transitory machine readable medium storing instructions for execution by logic device 168. In various embodiments, machine readable medium 176 may be included as part of portable device 101 and/or separate from portable device 101, with stored instructions provided to portable device 101 by coupling the machine readable medium 176 to portable device 101 and/or by portable device 101 downloading (e.g., via a wired or wireless link) the instructions from the machine readable medium (e.g., containing the non-transitory information).

Logic device 168 may be configured to process captured images and provide them to display component 178 for presentation to and viewing by the user. Display component 178 may include a display device such as a liquid crystal display (LCD), an organic light-emitting diode (OLED) display, and/or other types of displays as appropriate to display images and/or information to the user of portable device 101. Logic device 168 may be configured to display images and information on display component 178. For example, logic device 168 may be configured to retrieve images and information from memory 172 and provide images and information to display component 178 for presentation to the user of portable device 101.

Display component 178 may include display electronics, which may be utilized by logic device 168 to display such images and information.

User controls 170 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 170 may be integrated with display component 178 as a touchscreen to operate as both user controls 170 and display component 178. Logic device 168 may be configured to sense control input signals from user controls 170 and respond to sensed control input signals received therefrom. In some embodiments, portions of display component 178 and/or user controls 170 may be implemented by appropriate portions of a tablet, a laptop computer, a desktop computer, and/or other types of devices.

In various embodiments, user controls 170 may be configured to include one or more other user-activated mechanisms to provide various other control operations of portable device 101, such as auto-focus, menu enable and selection, field of view (FoV), brightness, contrast, gain, offset, spatial, temporal, and/or various other features and/or parameters.

Position sensor 179 may be implemented as any appropriate type of device used to determine a position (e.g., location) of portable device 101 in environment 102 (e.g., in an industrial facility containing assets 192 to be monitored). For example, in various embodiments, position sensor 179 may be implemented as a global positioning system (GPS) device, motion sensors (e.g., accelerometers, vibration sensors, gyroscopes, and/or others), depth sensing systems (e.g., time of flight cameras, LiDAR scanners, thermal cameras, visible light cameras, and/or others), antennas, other devices, and/or any combination thereof as desired. In some embodiments, position sensor 179 may send appropriate signals to logic device 168 for processing to determine the absolute and/or relative position of portable device 101 in environment 102.

Portable device 101 may include various types of other sensors 180 including, for example, temperature sensors and/or other sensors as appropriate.

Logic device 168 may be configured to receive and pass images from thermal and visible light imager interfaces 166A-B, additional data from position sensor 179 and sensors 180, and control signal information from user controls 170 to one or more external devices such as remote system 198 through communication interface 174 (e.g., through wired and/or wireless communications). In this regard, communication interface 174 may be implemented to provide wired communication over a cable and/or wireless communication over an antenna. For example, communication interface 174 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 174 may include an antenna coupled thereto for wireless communication purposes. In other embodiments, the communication interface 174 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, portable device 101 and/or its individual associated components may be associated with a particular network link such as for example a URL (Uniform Resource Locator), an IP (Internet Protocol) address, and/or a mobile phone number.

Portable device 101 may include various other components 182 such as speakers, displays, visual indicators (e.g., recording indicators), vibration actuators, a battery or other power supply (e.g., rechargeable or otherwise), and/or additional components as appropriate for particular implementations.

Although various features of portable device 101 are illustrated together in FIG. 1, any of the various illustrated components and subcomponents may be implemented in a distributed manner and used remotely from each other as appropriate. For example, remote system 198 may be implemented with any of the various components of portable device 101. Remote system 198 may communicate with portable device 101 to send and receive data therewith, perform remote processing for portable device 101, and/or other tasks (e.g., through appropriate communication interfaces 174 of portable device 101 and/or of remote system 198). For example, in some embodiments, thermal images, visible light images, position data, and/or additional information obtained by portable device 101 may be communicated to remote system 198 for further processing and/or storage. In this regard, remote system 198 may include a database 199 (e.g., maintained in an appropriate memory 172 of remote system 198) used for storage and recall of various images and/or other information to monitor historical temperatures of assets 192. In embodiments, remote system 198 and portable device 101 may communicate over a network 197. For example, remote system 198 may be implemented as a cloud-based system, although other configurations are contemplated. In various embodiments, remote system 198 may include any of the various components of portable device 101 as appropriate.

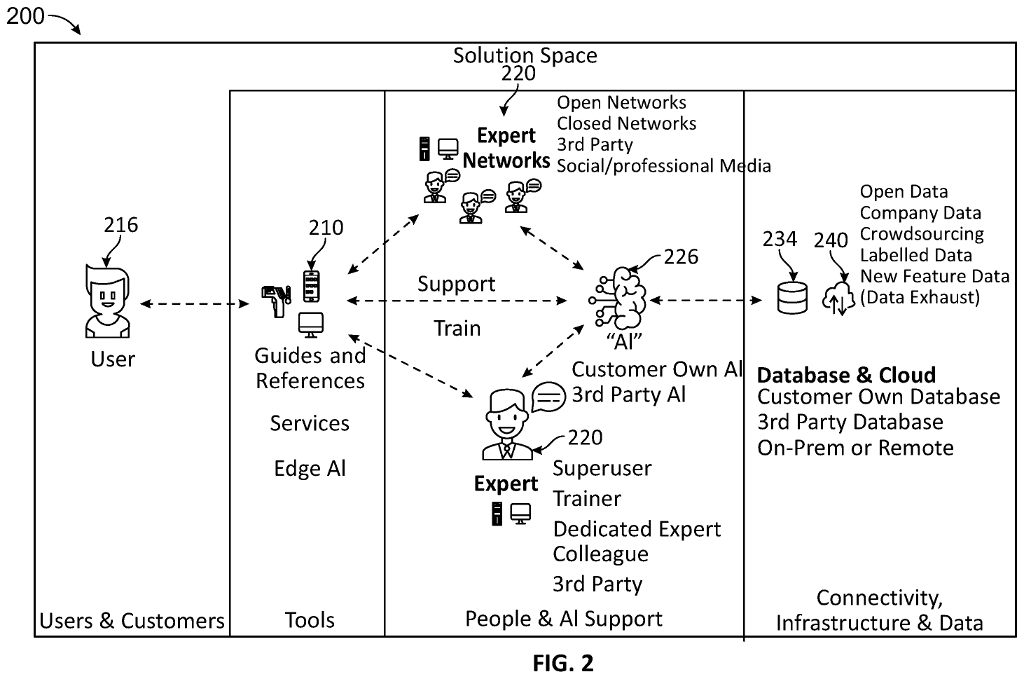

FIG. 2 illustrates a diagram of an operations system 200, in accordance with an embodiment of the disclosure. In this regard, operations system 200 identifies an example context in which inspection system 100 and/or remote system 198 may operate. As shown, operations system 200 may include one or more tools 210 (e.g., inspection system 100, portable device 101, and/or other tools) operated by one or more users 216 (e.g., customers of inspection system 100, portable device 101, etc.). For example, a user 216 may operate portable device 101 to take one or more inspection images of an asset (e.g., asset 192), such as to compare against a previous image of the asset to determine a status, health, or operational state of the asset. In embodiments, operations system 200 may present the current image relative to a previous image of the asset for comparison. The comparison between the current image and one or more previous images of the asset may facilitate an identification of a fault, failure, or undesired operation condition of the asset, or that the asset is operating satisfactorily, as described in detail below.

With continued reference to FIG. 2, operations system 200 may include third-party entities or devices to assist the user 216 and/or tools 210 in drawing correct conclusions regarding the status or health of the asset. For example, operations system 200 may include an associated expert 220 and/or one or more expert networks 222. Expert 220 and/or expert networks 222 may be in a networked relationship with tools 210 and/or one another to provide decision support and/or train user 216. Depending on the application, expert 220 may be a supervisor, trainer, colleague, or dedicated expert. Expert networks 222 may be open or closed networks of multiple experts providing multiple data points for decision support/training. In this manner, operations system 200 may leverage industry knowledge and experience for the unexperienced user 216.

In embodiments, operations system 200 includes one or more artificial intelligence (AI) networks 226 (e.g., artificial neural networks). AI networks 226 may be in-house networks or third-party networks running various AI algorithms, such as neural networks running a machine learning algorithm or other AI. AI networks 226 may be in a networked relationship with tools 210, expert 220, and/or expert networks 222 to further provide decision support regarding the health or status of the asset. In such embodiments, expert 220 and/or expert networks 222 may be used to train AI networks 226. In embodiments, various algorithms may be deployed on a tool (e.g., tools 210, inspection system 100, portable device 101, a camera or other device) with only the decision regarding the health or status of the asset transferred further into AI network 226. Such implementations may be referred to as edge AI.

As shown, operations system 200 may include one or more databases 234. In embodiments, database(s) 234 may include a remote database (e.g., database 199) operating on a remote server or cloud 240 (e.g., remote system 198). In embodiments, database(s) 234 may include an on-premises server, such as a local database, a hardware based server, or a private cloud, among other examples. Database(s) 234 may store various information associated with tools 210, asset 192, and/or other elements of operations system 200. For example, database(s) 234 may include open data, company data, and/or crowdsourced data. Database(s) 234 may be in a networked relationship with tools 210, expert 220, expert networks 222, and/or AI networks 226.

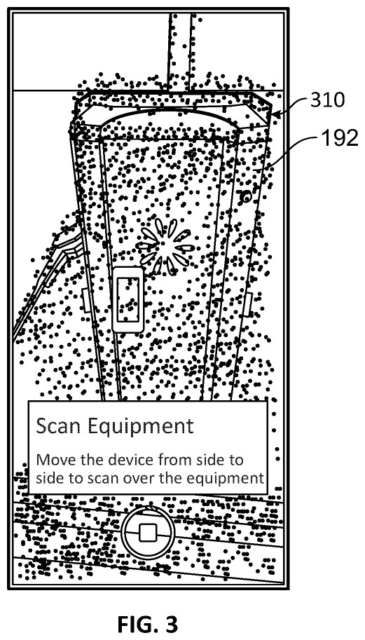

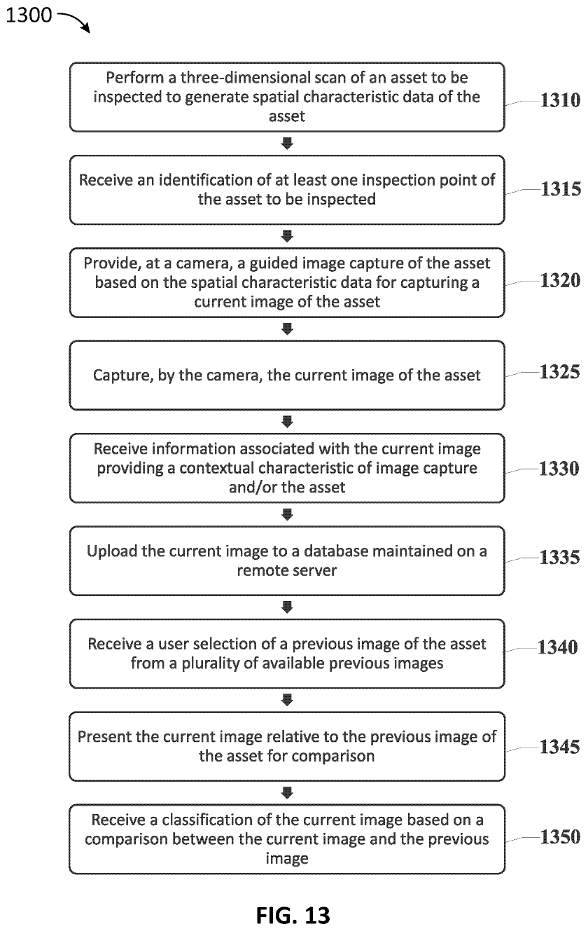

FIGS. 3 to 12 illustrate various features of a process of classifying images of assets under inspection as further discussed herein with regard to FIG. 13. All of the various features illustrated in FIGS. 3 to 12 are provided for purposes of example. Accordingly, it will be understood that other implementations may be used as appropriate in various implementations.

FIG. 3 illustrates a three-dimensional (3D) scan of an asset under inspection, in accordance with an embodiment of the disclosure. Referring to FIG. 3, asset 192 may be scanned (e.g., by portable device 101 or another camera of inspection system 100) to generate spatial characteristic data of asset 192. For example, portable device 101 may be moved from side to side and/or from top to bottom to scan over asset 192. In some embodiments, the 3D scan of the asset may be performed by another device, such as by a competent scanner used when scanning a larger area, with the scanned data set connected to portable device 101 for use in relocation of portable device 101 (e.g., guided image capture) and taking images, as described below. The 3D scan of asset 300 may generate multiple spatial points 310 used to define asset 192 in 3D space. As shown, the 3D scan may be displayed on portable device 101, such as on display component 178 in or near real-time.

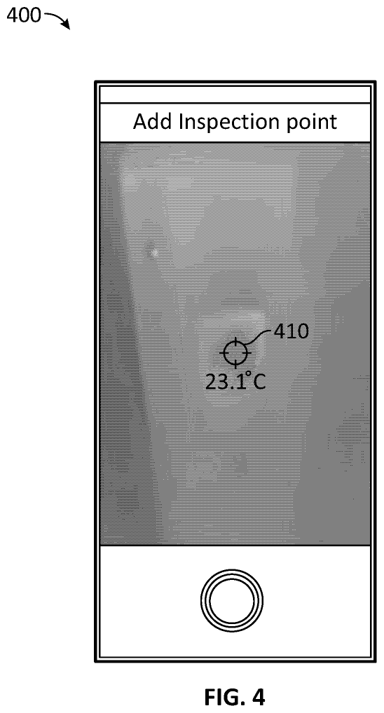

FIG. 4 illustrates an image 400 of an inspection point 410, in accordance with an embodiment of the disclosure. Referring to FIG. 4, portable device 101 may be used to capture a thermal image (as shown) and/or a visible light image of asset 300, which may be displayed on display component 178 in certain implementations. Once image 400 is captured, the system may receive an identification of at least one inspection point 410. For example, user 216 may identify inspection point 410 in image 400, such as via a touch screen display, although other configurations are contemplated. For example, inspection point 400 may be identified by a processor (e.g., automatically by logic device 168 operating a machine learning algorithm), by a remote user (e.g., expert 220), or by a remote system. Inspection point 400 may be any area of interest to monitor for asset 192, such as a charging port of a vehicle charger, a high voltage connection, a fuse switch, an area prone to excessive heat, etc.

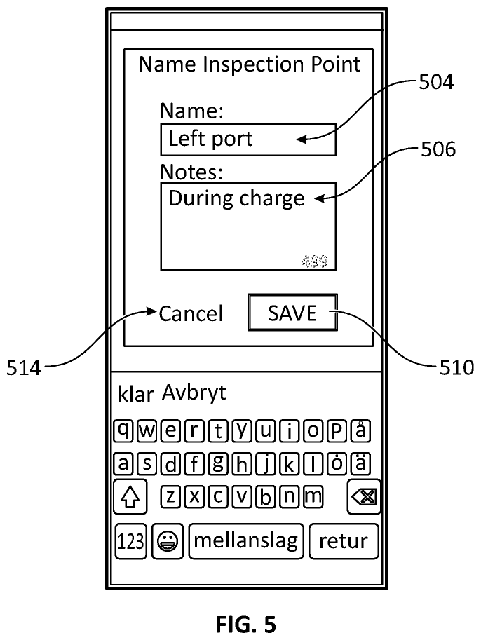

FIG. 5 illustrates an identification of inspection point 410, in accordance with an embodiment of the disclosure. Referring to FIG. 5, information associated with inspection point 410 and/or asset 192 may be created and stored for inspection point 410, such as via display component 178. For example, user 216 may provide a name 504 and one or more notes 506 for inspection point 410 while saving inspection point 410. Note(s) 506 may provide a contextual characteristic of inspection point 410 and/or asset 192, such as an operation state of inspection point 410/asset 192 (e.g., “during charge”), which may be used as a basis to later classify subsequent images of asset 192, as detailed below. In embodiments, a first executable control 510 may save the inspection point 410, and a second executable control 514 may cancel the saving of inspection point 410, although other configurations are contemplated.

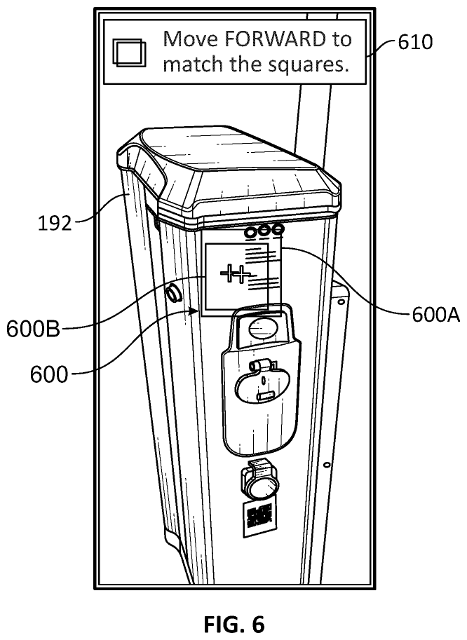

FIG. 6 illustrates a guided image capture of an asset under inspection (e.g., asset 192), in accordance with an embodiment of the disclosure. Referring to FIG. 6, the system may guide a manipulation of portable device 101, such as via display component 178, to align the camera relative to asset 192 to support the taking of similar images of asset 192 every time. Such configurations may ensure that portable device 101 is roughly the same distance and angle towards asset 192. In this manner, the system may ensure that a health/status determination of asset 192 is based on images with the same visual presentation (e.g., to ensure an “apples-to-apples” comparison). In embodiments, the guided image capture of asset 192 may be based on the spatial characteristic data generated with reference to FIG. 3, described above. For example, the generated spatial points 310 may be used to align portable device 101 relative to asset 192 in 3D space. The guided image capture may be configured to adjust at least one of a position, an angle, or a field of view of portable device 101 to align a current image of asset 192 with a previous image (e.g., image 400).

As shown, the guided image capture may include one or more alignment markers 600. The alignment markers 600 include a current image marker 600A and a previous image marker 600B. The current image marker 600A provides a visual representation of the current angle of portable device 101 towards asset 192. Similarly, the previous image marker 600B provides a visual representation of the angle of portable device 101 towards asset 192 of a previous image (e.g., image 400) of asset 192. The alignment markers 600 may provide feedback (e.g., visual feedback to the user) to aid alignment of the current image of asset 192.

In embodiments, the guided image capture may include one or more prompts 610 directing manipulation of portable device 101. For example, prompts 610 may direct the user to move portable device 101 (e.g., up, down, left, or right, rotate up, rotate down, rotate left, rotate right, etc.) to match current image marker 600A with previous image marker 600B.

Although a specific implementation is illustrated in FIG. 6, alignment markers 600 may include other visual representations to aid alignment (e.g., triangles, dots, crosshairs, etc.). Depending on the application, the manipulation may be performed by the user of portable device 101 (e.g., user 216), or the manipulation may be performed by another device (e.g., a robot), although other configurations are contemplated.

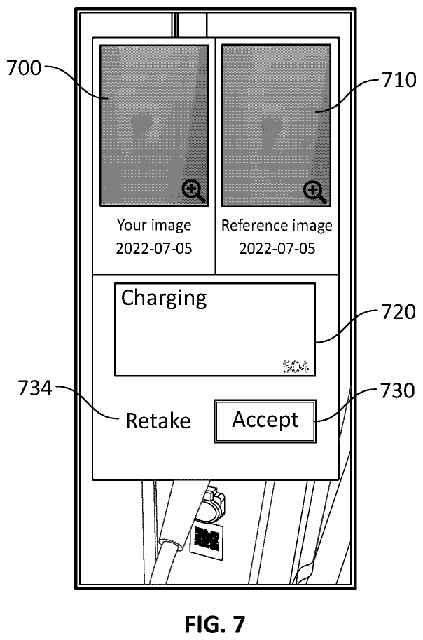

FIG. 7 illustrates an annotation of a current image of an asset under inspection (e.g., asset 192), in accordance with an embodiment of the disclosure. Referring to FIG. 7, portable device 101 may capture a current image 700 of asset 192 for comparison against a previous image 710 (e.g., a reference image), such as on display component 178. For example, during an inspection of asset 192, portable device 101 may capture current image 700 for use in monitoring a condition of asset 192, such as to detect faults, failures, or undesired operating conditions of asset 192. In embodiments, current image 700 may be presented together with previous image 710 of asset 192. For example, display component 178 may display current image 700 and previous image 710 simultaneously for viewing by a user of portable device 101, although other implementations are contemplated. For instance, in some implementations, current image 700 and previous image 710 may be displayed on a remote display component, such as on a display component of remote system 198 and/or expert networks 222, although other configurations are contemplated.

With continued reference to FIG. 7, information associated with current image 700 may be provided. For example, an annotation 720 of current image 700 may provide a contextual characteristic of image capture and/or asset 192. Such contextual characteristics may include an indication of the operation state of asset 192 (e.g., charging, off, on, warming up, cooling off, under fault conditions, steady-state operation, irregular operation, etc.). Depending on the application, the contextual characteristics may be provided by a user or automatically by a logic device (e.g., logic device 168 of portable device 101 and/or remote system 198). In embodiments, the contextual characteristic may be provided by a sensor (e.g., an environmental sensor, etc.). In embodiments, a first executable control 730 may accept the current image 700 and annotation 720, and a second executable control 732 may cause the system to retake the current image 700, although other configurations are contemplated

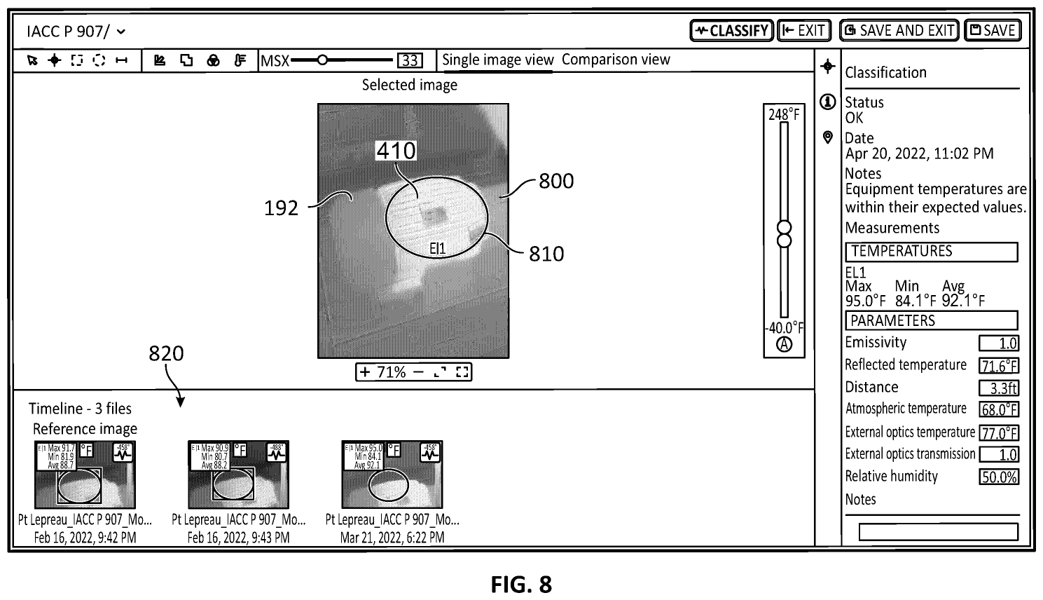

FIG. 8 illustrates a diagram of displaying multiple images of an asset under inspection (e.g., asset 192), in accordance with an embodiment of the disclosure. Referring to FIG. 8, a current image 800 of asset 192 may be captured and presented for viewing, such as on display component 178 of portable device 101 and/or remote system 198. As shown, current image 800 includes at least one inspection point (e.g., inspection point 410) of asset 192. Current image 800 may be provided with one or more measuring tools (e.g., temperature measurement boxes or areas 810, temperature measurement spots, etc.) placed on areas of interest (e.g., at inspection point(s) 410). In embodiments, the presentation of current image 800 may be adjusted, such as via adjustment of one or more image characteristics (e.g., color palette, temperature span settings, thermal brightness (level) settings, etc.) in a way to make areas of interest clearly visible. As shown, prior images 820 of asset 192 may also be displayed, such as in a timeline view below current image 800, although other configurations are contemplated.

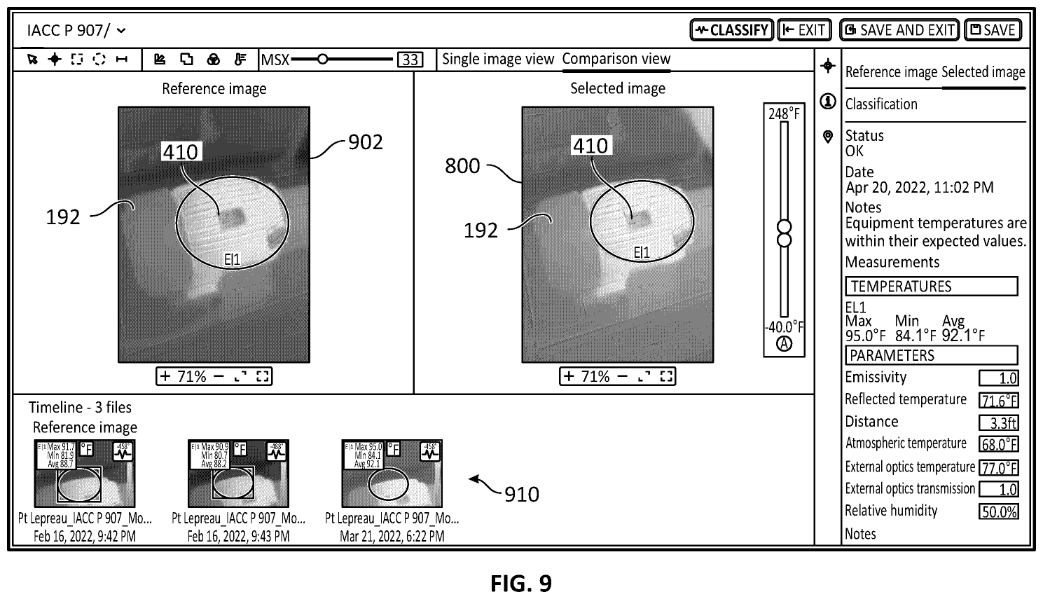

FIG. 9 illustrates a comparison between current and previous images of an asset under inspection, in accordance with an embodiment of the disclosure. Referring to FIG. 9, current image 800 may be presented relative to a previous mage 902 of asset 192 for comparison, such as on display component 178 of portable device 101 and/or remote system 198. Similar to current image 800, previous image 902 includes inspection point 410, so as to compare inspection point 410 between current image 800 and previous image 902, among other areas of asset 192. As shown, current image 800 may be displayed together with previous image 902 on a display component (e.g., display component 178), such as side-by-side, although other configurations are contemplated.

Previous image 902 may be any image used as reference against current image 800. In embodiments, previous image 902 may be any image taken previously of asset 192. For example, previous image 902 may be an image taken by an installer during installation of asset 192, an image taken by a manufacturer during manufacture of asset 192, or any other image of asset 192 taken at any time prior to current image 800. In embodiments, previous image 902 may be an image of a similar asset and not of asset 192 itself. For instance, previous image 902 may be an image of another device/equipment of the same model as asset 192 (e.g., a standard image of asset model, the same asset at another location, etc.) or an image of another device/equipment having properties and/or a configuration similar to asset 192 (e.g., a prior model of asset 192, a comparable model of asset 192, etc.).

Previous image 902 may be provided in many ways. For example, previous image 902 may be provided (e.g., to portable device 101) by an image database maintained by a server (e.g., by database 199 of remote system 198). In some embodiments, previous image 902 may be taken by a camera different than portable device 101. For example, as noted above, previous image 902 may be taken by the installer during installation of asset 192, by the manufacturer during manufacture of asset 192, or by another person or device.

In embodiments, previous image 902 may be selected or identified (e.g., by a user, by system 100, etc.) for use in comparing against current image 800. For example, current image 800, previous image 902, and a plurality of available previous images 910 may be displayed together, such as in a timeline view in chronological order. In such embodiments, a user may select from among the multiple previous images 910, an image to use as previous image 902, such as toggling between various prior images of asset 192. Such embodiments may also enable a trend analysis of asset 192, which may provide additional decision support.

In embodiments, previous image 902 may be selected automatically, or at least selected by default, based on a user setting. For instance, the user setting may select, as the default previous image 902, the last inspection image of asset 192, the earliest image taken of asset 192, or the latest image of asset 192 taken during a similar time of day and/or year (e.g., morning, afternoon, fall, October, etc.) and/or similar environmental conditions (e.g., ambient temperature, etc.). Depending on the application, the selection of previous image 902 can be done by the same user doing the inspection, or the selection can be done as guidance by a more experienced user (e.g., by expert 220, expert network 222, or AI network 226).

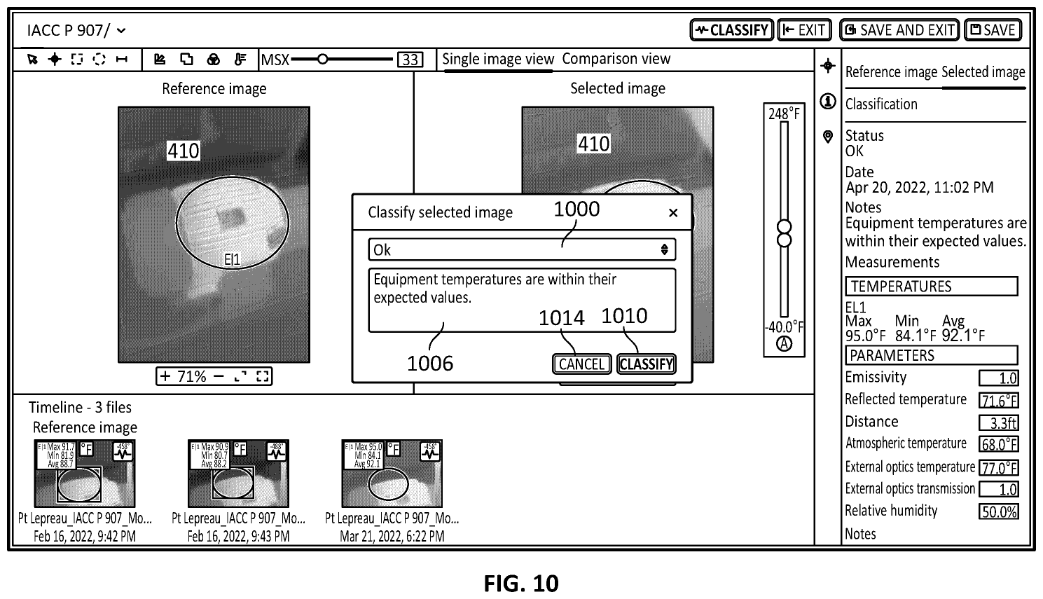

FIG. 10 illustrates a classification of current image 800, in accordance with an embodiment of the disclosure. Referring to FIG. 10, a comparison between current image 800 and previous image 902 may indicate a status of asset 192, such as whether asset 192 is operating within or outside specifications. Based on the comparison, current image 800 may be classified. For example, the comparison between current image 800 and previous image 902 may indicate that asset 192 is operating correctly, has minor issues, or in a critical state, among other states.

As shown, classification of current image 800 may include a status indication 1000 and a notes indication 1006. Status indication 1000 may provide a classification of current image 800 based on comparison between current image 800 and previous image 902. Notes indication 1006 may provide contextual information regarding the classification of current image 800. For example, notes indication 1006 may provide information regarding operation of asset 192 (e.g., “equipment temperatures are within their expected values”; “temperatures are elevated from previous inspection”; etc.), of asset 192 itself (e.g., “equipment appears dirty”; “equipment missing heat shield”; etc.), or of current image 800 (e.g., “incomplete image”; “quality of image is poor”; etc.).

With continued reference to FIG. 10, a first executable control 1010 may cause the system to classify current image 800 with the information provided in status indication 1000 and notes indication 1006. In embodiments, classification of current image 800 may cause current image 800 to be uploaded to a database maintained on a remote server, although other configurations are contemplated. A second executable control 1014 may cause the system to cancel the classification process of current image 800.

Depending on the application, the comparison and classification of current image 800 may be performed by a user or by a processor. For example, user 216 may visually compare current image 800 to previous image 902 on display component 178, and provide a classification of current image 800 based on the comparison. In embodiments, expert 220 may visually compare current image 800 to previous image 902 on a remote display component, and provide a classification of current image 800 based on the comparison. In embodiments, current image 800 may be analyzed and classified by logic device 168 and/or AI network 226, as described above.

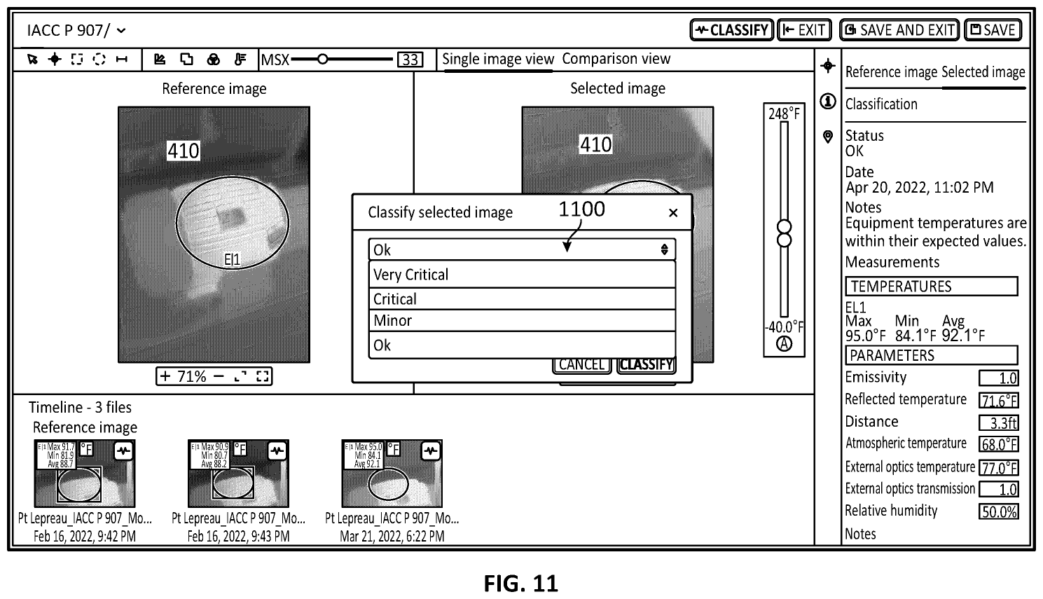

FIG. 11 illustrates a classification selection of current image 800, in accordance with an embodiment of the disclosure. Referring to FIG. 11, status indication 1000 may include a dropdown menu 1100 having multiple classifications for user selection. For instance, a user may select one of multiple classification conditions provided in dropdown menu 1100 on display component 178 of portable device 101 and/or remote system 198, such as “OK,” “Minor,” “Critical,” or “Very Critical,” although other configurations are contemplated. In embodiments, the user may adjust dropdown menu 1100, such as adding additional classification conditions to dropdown menu 1100 or removing classification conditions from dropdown menu 1100.

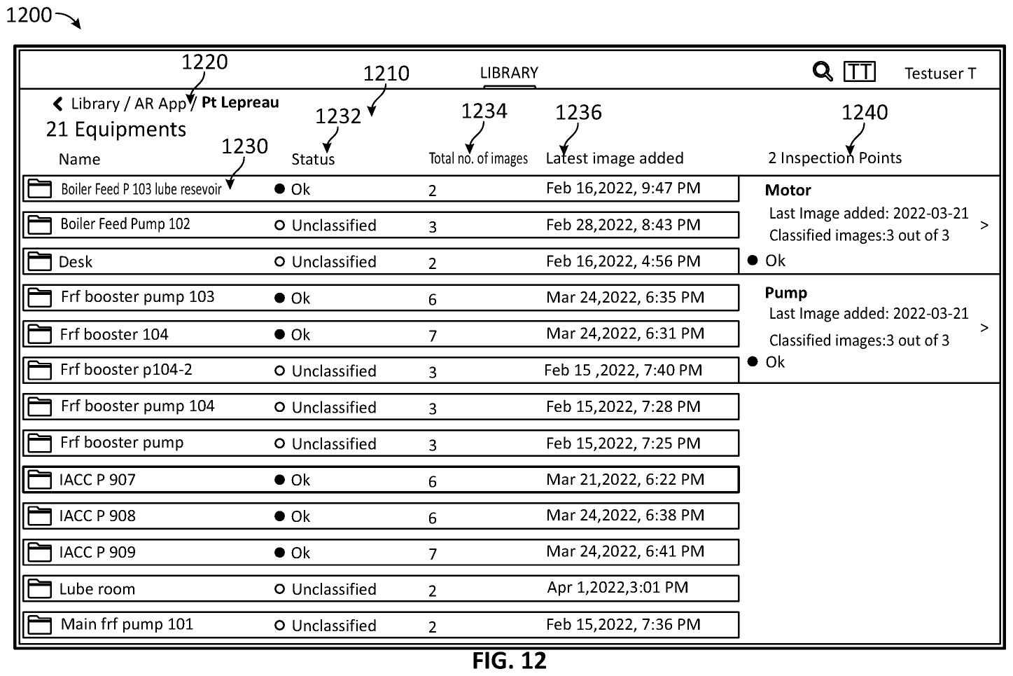

FIG. 12 illustrates a diagram of an inspection board 1200 (e.g., for display on display component 178 of portable device 101 and/or remote system 198), in accordance with an embodiment of the disclosure. Referring to FIG. 12, inspection board 1200 may provide an overview of multiple assets, such as for a user to get a quick and clear understanding of each asset's health status. As shown, inspection board 1200 may include a library view 1210 listing the equipment or assets located at a physical location (e.g., warehouse, work center, operations center, etc.) (e.g., “Pt Lepreau” as illustrated in FIG. 12). In embodiments, the user may switch physical locations in inspection board 1200. For example, the user may switch between viewing the equipment/assets at a first location and a second location, such as via a folder structure 1220, although other configurations are contemplated. Folder structure 1220 may allow the user to switch between other information bucket within the folder structure 1220.

At each physical location, the equipment or assets under inspection protocols are listed in an equipment view 1230. Equipment view 1230 may provide an overview of each equipment or asset, such as providing information regarding each asset's current status 1232, total number of images taken 1234, latest image time 1236, or the like, such as organized in rows and columns. In this manner, the user may quickly determine the health and inspection statuses of each asset by simply viewing equipment view 1230.

In embodiments, the user may drill down into each asset to ascertain additional information regarding the asset. For example, the user may select an asset in equipment view 1230 to bring up an inspection view 1240 for the selected asset. Inspection view 1240 may list the inspection points for the selected asset. Information related to each inspection point is also provided in inspection view 1240, such as a status, the number of classified images, the time when the last image was added for the inspection point, or the like.

FIG. 13 illustrates a flow diagram of a process 1300 of classifying a current image of an asset under inspection, in accordance with an embodiment of the disclosure. In embodiments, process 1300 may be performed by logic device 168 of portable device 101. In some embodiments, process 1300 may be performed during runtime operation of inspection system 100 to permit real-time inspection of one or more assets (e.g., asset 192). Note that one or more operations in FIG. 13 may be combined, omitted, and/or performed in a different order as desired.

In some embodiments, any of the various blocks of process 1300 may be performed based on at least one of a predetermined inspection route, a detected position of portable device 101 relative to an asset (e.g., GPS positioning), a communication between portable device 101 and an asset (e.g., near-field communication (NFC), wireless communication, Bluetooth communication, etc.), or user input. For example, during routine inspections, the user may provide an indication (e.g., via user controls 170, voice control, etc.) to proceed to the next asset for inspection. In embodiments, the use of an inspection route may be the same or similar to that disclosed in U.S. Provisional Patent Application No. 63/003,111, filed Mar. 31, 2020, and International Patent Application No. PCT/US2021/025011 filed Mar. 30, 2021, all of which are hereby incorporated by reference in their entirety.

In block 1310, process 1300 includes performing a 3D scan of an asset to be inspected to generate spatial characteristic data of the asset. For example, portable device 101 may scan asset 192 to generate spatial points 310 used to define asset 192 in 3D space, such as in a manner as described above. In some embodiments, block 1310 may be performed by another device, such as by a competent scanner used when scanning a larger area, with the scanned data set connected to portable device 101 for use in relocation of portable device 101 (e.g., guided image capture) and taking images, as described above. In some embodiments, block 1310 may be performed during an initial inspection of the asset (e.g., a first iteration of process 1300) and may be omitted during subsequent inspections of the asset (e.g., subsequent iterations of process 1300 performed to capture additional images of the asset later in time). Accordingly, the asset may be scanned during the initial inspection and optionally not scanned during subsequent inspections. FIG. 3 illustrates an example interface that may be presented to the user during block 1310.

In block 1315, process 1300 includes receiving an identification of at least one inspection point of the asset to be inspected. In embodiments, the identification may be performed by a user. For example, a user may identify one or more inspection points 410 in an image of asset 192, such as via a touch screen display or other executable control. In embodiments, one or more inspection points 410 may be identified automatically by a processor. The inspection point may be any area of interest of asset 192, such as areas of asset 192 requiring or benefitting from repeated inspection. FIG. 4 and/or FIG. 5 illustrate example interfaces that may be presented to the user during block 1315.

In block 1320, process 1300 includes providing, at the camera, a guided image capture of the asset based on the spatial characteristic data for capturing a current image of asset 192. Block 1320 may include guiding a manipulation of portable device 101 to align portable device 101 relative to asset 192 to ensure capture of similar images of asset 192 every time. Block 1320 may include adjusting at least one of a position, an angle, or a field of view of portable device 101 to align a current image of asset 192 to a previous image of asset 192. FIG. 6 illustrates an example interface that may be presented to the user during block 1320.

In block 1325, process 1300 includes capturing, by the camera, the current image of the asset under inspection. For instance, thermal imaging subsystem 110A and/or visible light imaging subsystem 110B may be used to capture current image 800 of asset 192, such as in a manner as described above. The current image may include at least one inspection point of asset 192. FIG. 4 and/or FIG. 7 illustrate example interfaces that may be presented to the user during block 1325.

In block 1330, process 1300 includes receiving information associated with the current image providing a contextual characteristic of image capture and/or the asset. For example, an indication of the operation state of asset 192 (e.g., charging, off, on, warming up, cooling off, under fault conditions, steady-state operation, irregular operation, etc.) may be provided. Block 1330 may include receiving a user annotation of the current image, although other configurations are contemplated, such as contextual information provided by a sensor (e.g., an environmental sensor) and/or by a logic device. FIG. 7 illustrates an example interface that may be presented to the user during block 1330.

In block 1335, process 1300 includes uploading the current image to a database maintained on a remote server. For example, current image 800 may be uploaded to database 199 on remote system 198. In embodiments, the database may include a previous image of asset 192, such as for comparison with current image 800 during inspection, as described herein.

In block 1340, process 1300 includes receiving a user selection of a previous image of the asset from a plurality of available previous images. For example, a user may select previous image 902 for use in comparing against current image 800, the previous image 902 including the inspection point(s) 410 of interest of asset 192. Block 1340 may include displaying a plurality of available previous images (e.g., images 910), such as chronologically in a timeline view. A user may select an image from among the multiple previous images 910 to use as previous image 902, such as toggling between the various prior images 910 of asset 192.

In block 1345, process 1300 includes presenting the current image relative to the previous image of the asset for comparison. Block 1345 may include displaying the current and previous images simultaneously on a display component (e.g., display component 178) for viewing by a user. In embodiments, the display component may be associated with a device separate from portable device 101 (e.g., on expert network 222, on remote system 198, etc.). Block 1345 may include displaying the current and previous images side-by-side for comparison. Block 1345 may include displaying the current image, the previous image, and a plurality (e.g., subset) of available prior images together (e.g., in a timeline view in chronological order). The comparison may be performed by a user or by a processor, such as a processor operating on portable device 101 and/or remote system 198. FIG. 8 and/or FIG. 9 illustrate example interfaces that may be presented to the user during block 1345.

In block 1350, process 1300 includes receiving a classification of the current image based on a comparison between the current image and the previous image. Block 1350 may include classifying whether asset 192 is operating within or outside specifications, whether asset 192 is in a critical state, or the like. FIG. 10 and/or FIG. 11 illustrate example interfaces that may be presented to the user during block 1350.

In various embodiments, any of the blocks of process 1300 may be repeated in accordance with subsequent inspections of the asset as discussed. In addition, any of the blocks of process 1300 may be repeated for inspections of other assets (e.g., a plurality of assets distributed among different locations).

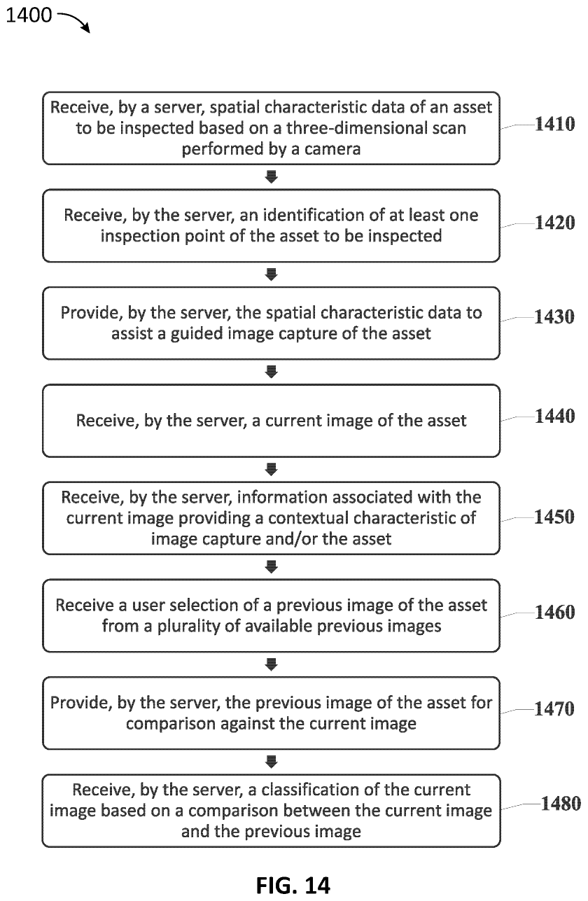

FIG. 14 illustrates a flow diagram of another process 1400 of classifying a current image of an asset under inspection, in accordance with an embodiment of the disclosure. In embodiments, process 1400 may be performed by remote system 198. In some embodiments, process 1400 may be performed during runtime operation of inspection system 100 to permit real-time inspection of one or more assets (e.g., asset 192). Note that one or more operations in FIG. 14 may be combined, omitted, and/or performed in a different order as desired.

In block 1410, process 1400 includes receiving, by a server, spatial characteristic data of an asset to be inspected based on a 3D scan performed by a camera. For example, portable device 101 may scan asset 192 to generate spatial points 310 used to define asset 192 in 3D space, such as in a manner as described above. In block 1410, the spatial characteristic data generated by the 3D scan is uploaded to a server, such as remote system 198.

In block 1420, process 1400 includes receiving, by the server, an identification of at least one inspection point of the asset to be inspected. As noted above, a user or processor may identify inspection point(s) 410 of asset 192 for repeated inspection. The inspection point information may be uploaded to remote system 198.

In block 1430, process 1400 includes providing, by the server, the spatial characteristic data to assist a guided image capture of the asset. Block 1430 may include providing the spatial characteristic data to portable device 101 or another device (e.g., a robot) to guide a manipulation of portable device 101 to align portable device 101 relative to asset 192 to ensure repeated capture of similar images of asset 192. For example, the guided image capture may adjust at least one of a position, an angle, or a field of view of portable device 101 to align a current image with a previous image of asset 192.

In block 1440, process 1400 includes receiving, by the server, a current image of the asset. For instance, thermal imaging subsystem 110A and/or visible light imaging subsystem 110B of portable device 101 may be used to capture current image 800 of asset 192, such as in a manner as described above, the current image 800 including the inspection point(s) 410 of interest of asset 192.

In block 1450, process 1400 includes receiving, by the server, information associated with the current image providing a contextual characteristic of image capture and/or the asset. For instance, an indication of the operation state of asset 192 (e.g., charging, off, on, warming up, cooling off, under fault conditions, steady-state operation, irregular operation, etc.) may be provided. Block 1330 may include receiving a user annotation of current image 800, although other configurations are contemplated, such as contextual information provided by a sensor (e.g., an environmental sensor) and/or by a logic device.

In block 1460, process 1400 includes receiving a user selection of a previous image of the asset from a plurality of available previous images. For instance, a user may select previous image 902 for use in comparing against current image 800, the previous image 902 including the inspection point(s) 410 of interest of asset 192. Block 1340 may include displaying a plurality of available previous images (e.g., images 910), such as chronologically in a timeline view. A user may select an image from among the multiple previous images 910 to use as previous image 902, such as toggling between the various prior images 910 of asset 192

In block 1470, process 1400 includes providing, by the server, the previous image of the asset for comparison against the current image. For example, remote system 198 may provide previous image 902 to portable device 101, expert 220, expert network 222, and/or AI network 226 for comparison against current image 800. Block 1470 may include displaying the current and previous images on a display component for viewing by a user, such as in a manner as described above.

In block 1480, process 1400 includes receiving, by the server, a classification of the current image based on a comparison between the current image and the previous image. The classification may include an operating state of asset 192 (e.g., OK, critical, etc.) based on current image 800.

In view of the present disclosure, it will be appreciated that various techniques are provided to facilitate image-based classification of assets under inspection based on repeated capture of comparable and useful images of the assets. For example, a health status may be determined per image of an asset based on a comparison between a current image and one or more previous images of the asset (along with other historical asset data and contextual information). The health status may be presented for quick and clear understanding, such as in an inspection board providing an overview of all assets under inspection, which may facilitate the identification of critical issues and trending.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
capturing, by a camera, a current image of an asset under inspection, wherein the current image comprises at least one inspection point of the asset;
presenting the current image relative to a previous image of the asset for comparison, wherein the previous image comprises the at least one inspection point of the asset; and
receiving a classification of the current image based on a comparison between the current image and the previous image.

2. The method of claim 1, wherein:
the presenting comprises displaying the current image and the previous image simultaneously on a display component for viewing by a user; and
the comparison and the classification are performed by the user.

3. The method of claim 2, further comprising receiving a user selection of the previous image from a plurality of available previous images for use in the comparison.

4. The method of claim 3, wherein the presenting comprises displaying the current image, the previous image, and the plurality of available previous images in a timeline view in chronological order.

5. The method of claim 2, wherein the display component is associated with a device separate from the camera.

6. The method of claim 1, wherein the comparison and the classification are performed by a processor.

7. The method of claim 6, further comprising:
uploading the current image to a database maintained on a remote server, the database comprising the previous image; and
wherein the processor is operating on the remote server.

8. The method of claim 1, further comprising:
receiving an identification of the at least one inspection point of the asset; and
receiving information associated with the current image providing a contextual characteristic of image capture and/or the asset.

9. The method of claim 1, further comprising:
performing, by the camera, a three-dimensional scan of the asset to generate spatial characteristic data of the asset; and
providing, at the camera, a guided image capture of the asset based on the spatial characteristic data, wherein the guided image capture is configured to adjust at least one of a position, an angle, or a field of view of the camera to align the current image with the previous image.

10. A system configured to perform the method of claim 1.

11. A method comprising:
receiving, by a server from a camera, a current image of an asset under inspection, wherein the current image comprises at least one inspection point of the asset;
providing, by the server, a previous image of the asset for comparison against the current image, wherein the previous image comprises the at least one inspection point of the asset; and
receiving, by the server, a classification of the current image based on a comparison between the current image and the previous image.

12. The method of claim 11, wherein:
the comparison comprises displaying the current image and the previous image simultaneously on a display component for viewing by a user; and
the comparison and the classification are performed by the user.

13. The method of claim 12, further comprising receiving a user selection of the previous image from a plurality of available previous images for use in the comparison.

14. The method of claim 13, wherein the displaying comprises displaying the current image, the previous image, and the plurality of available previous images in a timeline view in chronological order.

15. The method of claim 12, wherein the display component is associated with a device separate from the camera.

16. The method of claim 11, wherein the comparison and the classification are performed by a processor.

17. The method of claim 16, wherein the processor is operating on the server.

18. The method of claim 11, further comprising:
receiving, by the server, an identification of the at least one inspection point of the asset; and
receiving, by the server, information associated with the current image providing a contextual characteristic of image capture and/or the asset.

19. The method of claim 11, further comprising:
receiving, by the server, spatial characteristic data of the asset based on a three-dimensional scan of the asset; and
providing, by the server, the spatial characteristic data to assist a guided image capture of the asset, wherein the guided image capture is configured to adjust at least one of a position, an angle, or a field of view of the camera to align the current image with the previous image.

20. A system configured to perform the method of claim 11.
